(19) United States
(12) Patent Application Publication
(10) Pub. No.: US 2007/0042163 A1
(43) Pub. Date: Feb. 22, 2007

(54) Film for hydraulic transfer and hydraulically transferred body

(75) Inventors: Toshirou Ariga, Chiba-shi (JP); Yoshitomo Nagata, Sakura-shi (JP); Takashi Suzuki, Sakura-shi (JP); Yukihiko Kawaharada, Sakura-shi (JP)

Correspondence Address: DARBY & DARBY P.C., P. O. BOX 5257, NEW YORK, NY, 10150-5257, US

(73) Assignee: Dainppon Ink and Chemicals, Inc., Tokyo (JP)

(21) Appl. No.: 10/574,040

(22) PCT Filed: Sep. 30, 2004
(86) PCT No.: PCT/JP04/14374

§ 371 Date: Mar. 28, 2006

(30) Foreign Application Priority Data
Sep. 30, 2003 (JP) 2003-340351

(51) Int. Cl. B41M 5/00

(52) U.S. Cl. 428/195.1

(57) ABSTRACT

A film for hydraulic transfer having a supporting film formed from a water-soluble or water-swelling resin, and a transfer layer that is soluble in organic solvent provided on top of the supporting film, in which the transfer layer includes a curable resin layer that is curable by irradiation with an active energy beam, and a decorative layer composed of an ink or a coating film, wherein the curable resin layer is non-adhesive at room temperature, and contains: 1) a non-polymerizable thermoplastic resin (A), and, 2) a radical polymerizable oligomer (B1), having a weight average molecular weight within a range from 700 to 3,000 and being compatibility with the non-polymerizable thermoplastic resin (A).

### CROSS REFERENCE TO PRIOR APPLICATION

This is a U.S. National Phase Application under 35 U.S.C. §371 of International Patent Application No. PCT/JP2004/014374 filed Sep. 30, 2004, and claims the benefit of Japanese Patent Application No. 2003-340351 filed Sep. 30, 2003, both of which are incorporated by reference herein. The International Application was published in Japanese on Apr. 7, 2005 as WO 2005/030496 a1 under PCT Article 21(2).

### TECHNICAL FIELD

The present invention relates to a film for hydraulic transfer having a curable resin layer and a decorative layer, and a hydraulically transferred body obtained by hydraulically transferring the film.

### BACKGROUND ART

Hydraulic transfer is a method of transferring a transfer layer onto a transfer target body by floating a film for hydraulic transfer having a supporting film composed of a water-soluble or water-swelling resin and a transfer layer on a water surface with the supporting film facing downward, softening the transfer layer using an organic solvent known as an activator, and then submerging the transfer target body in the water by pushing it down onto the transfer film.

The hydraulic transfer method is capable of applying an intricately patterned decorative layer onto a complex three-dimensional molded body, but because an additional step is required after the hydraulic transfer in which a curable resin is spray coated onto the hydraulically transferred decorative layer as a protective layer, obtaining the transferred body requires a two step process. Furthermore, because the spray coating process requires coating equipment in addition to the hydraulic transfer equipment, high costs are incurred. Consequently, there is a demand for a hydraulic transfer method that uses a one step process in order to simplify the process and lower costs.

In response to this demand, a technique has been disclosed wherein a film for hydraulic transfer in which the transfer layer contains both a thermoplastic resin layer (a surface protection layer) and a decorative layer is used to transfer the thermoplastic resin layer and the decorative layer to the transfer target body in one step (for example, see patent reference 1 (Japanese Unexamined Patent Application, First Publication No. Hei 4-197699)). However, because in this technique the surface protection layer is formed from a thermoplastic resin, specifically a copolymer of butyl acrylate and ethyl acrylate, the coating film was not curable, and the physical and chemical durability of the surface protection layer, in terms of solvent resistance and surface hardness for example, was inadequate.

Furthermore, a method of manufacturing a molded product with a curable resin layer has been disclosed as a hydraulic transfer method that uses a one step process, wherein the coating layer is composed of a polymer having a glass transition temperature within a range from 0 to 250° C. and containing radical polymerizable unsaturated groups, and this coating layer is transferred to the transfer target body in an uncured state using a hydraulic transfer sheet having a non-adhesive coating layer that is solid at room temperature, and the coating layer is then cured by ionizing radiation or heat (for example, see patent reference 2 (Japanese Unexamined Patent Application, First Publication No. Sho 64-22378 (Japanese Examined Patent Application, Second Publication No. Hei 7-29084))).

Because the film for hydraulic transfer described in the patent reference 2 uses a polymer for the compound containing radical polymerizable unsaturated groups, adhesion is poor in the uncured state. Moreover, the difficulty of softening the polymer using an activator meant that in some cases transfer defects occurred wherein localized portions of the transfer layer failed to transfer. When the solubility within the activator was increased to prevent transfer defects, the decorative layer dissolved excessively, deforming the pattern of the decorative layer. Consequently, there was a problem in that transfer without transfer defects could not be achieved without deforming the pattern of the decorative layer.

### DISCLOSURE OF INVENTION

### Problems to be Solved by the Invention

Accordingly, an object of the present invention is to provide a film for hydraulic transfer with a curable resin layer and a decorative layer, for use within a hydraulic transfer method that uses a one step process and is capable of achieving transfer without transfer defects and without deforming the pattern of the decorative layer.

### MEANS FOR SOLVING THE PROBLEMS

The inventors of the present invention conducted research into films for hydraulic transfer with a curable resin layer and a decorative layer that were capable of achieving the above object, and discovered that the object could be achieved by using a curable resin layer which combines a thermoplastic resin selected from the group consisting of acrylic resins and polyester resins with a specific type of oligomer.

Furthermore, from experimenting with variations in the weight average molecular weight of the thermoplastic resin, the inventors discovered the following:

1) If the weight average molecular weight of the thermoplastic resin is too small, then the high solubility caused by the activator means that the pattern of the decorative layer is deformed easily. While if the thermoplastic resin content is increased and the radical polymerizable compound content is reduced to alleviate this problem to attempt to reduce destruction of the pattern of the decoration layer, the strength of the cured film cannot be maintained.

2) If the weight average molecular weight of the thermoplastic resin is too large, then achieving adequate softening with the activator is difficult. Accordingly, softening requires the use of an activator with stronger dissolution power. Using an activator with such strong dissolution power leads to destruction of the pattern of the decorative layer.

Based on these findings, the inventors discovered that a film for hydraulic transfer in which the thermoplastic resin is a thermoplastic resin selected from the group consisting of acrylic resins having a weight average molecular weight within a range from 70,000 to 250,000 and polyester resins having a weight average molecular weight within a range from 30,000 to 70,000, and the radical polymerizable compound is a radical polymerizable oligomer selected from the group consisting of epoxy acrylates, polyester acrylates and urethane acrylates, having a weight average molecular weight of 700 to 3,000 and being compatibility with the non-polymerizable thermoplastic resin (A), achieves the object described above, and they were thus able to complete the present invention.

In other words, the present invention provides a film for hydraulic transfer which includes a supporting film formed from a water-soluble or water-swelling resin, and a transfer layer that is soluble in organic solvent provided on top of the supporting film, in which the transfer layer includes a curable resin layer that is curable by irradiation with an active energy beam, and a decorative layer composed of an ink or a coating film, wherein

the curable resin layer is non-adhesive at room temperature, and contains

1) a non-polymerizable thermoplastic resin (A) selected from the group consisting of acrylic resins having a weight average molecular weight within a range from 70,000 to 250,000 and polyester resins having a weight average molecular weight within a range from 30,000 to 70,000, and,

2) a radical polymerizable oligomer (B1) selected from the group consisting of epoxy acrylates, polyester acrylates, and urethane acrylates, having a weight average molecular weight within a range from 700 to 3,000 and being compatibility with the non-polymerizable thermoplastic resin (A).

### EFFECTS OF THE INVENTION

With the film for hydraulic transfer of the present invention, a transfer layer having a curable resin layer and a decorative layer can be hydraulically transferred in one step without transfer defects and without deforming the pattern.

### BEST MODE FOR CARRYING OUT THE INVENTION

(Supporting Film)

The supporting film composed of a water-soluble or water-swelling resin used in the film for hydraulic transfer of the present invention is a film formed from a resin that either dissolves or swells in water.

As the supporting film composed of a water-soluble or water-swelling resin, films as PVA (polyvinyl alcohol), polyvinylpyrrolidone, acetylcellulose, polyacrylamide, acetylbutylcellulose, gelatin, glue, sodium alginate, hydroxyethylcellulose, and carboxymethylcellulose can be used.

Of these films, PVA film, which is typically used as a film for hydraulic transfer, is most preferred because it dissolves easily in water, is readily available, and is also suited to printing of the curable resin layer. The thickness of the supporting film is preferably within a range from 10 to 200 μm.

(Transfer Layer)

The transfer layer provided on top of the supporting film of the film for hydraulic transfer of the present invention includes a curable resin layer that can be cured by an active energy beam (hereafter referred to as the curable resin layer). Furthermore, the transfer layer contains the curable resin layer, and a decorative layer composed of a printed ink coating film or a coating film (hereafter referred to as the decorative layer) provided thereon. The curable resin layer in the present invention does not cure at room temperature, but can be cured by an active energy beam to form a cured resin layer.

(Curable Resin Layer)

(Non-Polymerizable Thermoplastic Resin (A))

As the curable resin layer of the film for hydraulic transfer of the present invention, a non-polymerizable thermoplastic resin (A) selected from the group consisting of acrylic resins having a weight average molecular weight within a range from 70,000 to 250,000 and polyester resins having a weight average molecular weight within a range from 30,000 to 70,000 is used.

(Acrylic Resin)

As the acrylic resin used as the non-polymerizable thermoplastic resin (A) in the present invention, poly(meth)acrylates are most preferred as they offer high Tg values and are suitable for enhancing the drying characteristics of the curable resin layer. Poly(meth)acrylates containing polymethylacrylate as the principal component, with a weight average molecular weight within a range from 100,000 to 200,000, and preferably from 100,000 to 150,000 are particularly preferred as they exhibit excellent transparency, solvent resistance, and abrasion resistance.

Furthermore, as the copolymer components of the poly(meth)acrylate, by using carboxyl group-containing radical polymerizable monomers such as (meth)acrylic acid to adjust the acid value of the polymer to a value within a range from 1 to 10, adhesion to the supporting film and adhesion between the transfer target body and the curable resin layer can be enhanced.

(Polyester)

If a polyester resin is used as the non-polymerizable thermoplastic resin (A), a film for hydraulic transfer with a feeling of depth and excellent flexibility can be provided.

The polyester resin used in the present invention is preferably a polyester resin obtained by copolymerizing an aromatic or aliphatic dicarboxylic acid and an aromatic or aliphatic diol.

The polyester resin is preferably a single polyester resin obtained by copolymerizing an aromatic or aliphatic dicarboxylic acid and an aliphatic diol, or a mixture of two or more such polyester resins. Of these resins, a mixture of polyester resins synthesized from an aromatic dicarboxylic acid and an aliphatic diol is most preferred.

Specific examples of aromatic dicarboxylic acids include terephthalic acid, isophthalic acid, orthophthalic acid, 1,5-naphthalenedicarboxylic acid, 2,6-naphthalenedicarboxylic acid, 4,4′-diphenyldicarboxylic acid, 2,2′-diphenyldicarboxylic acid, and 4,4′-diphenyl ether dicarboxylic acid.

Examples of aliphatic dicarboxylic acids include adipic acid, suberic acid, sebacic acid, 1,3-cyclohexanedicarboxylic acid, 1,2-cyclohexanedicarboxylic acid, and 4-methyl-1,2-cyclohexanedicarboxylic acid.

Examples of aliphatic diols include ethylene glycol, propylene glycol, 1,3-propanediol, 2-methyl-1,3-propanediol, 1,2-butanediol, 1,3-butanediol, 1,5-pentanediol, 3-methyl-1,5-pentanediol, neopentyl glycol, diethylene glycol, dipropylene glycol, 2,2,4-trimethyl-1,3-pentanediol, neopentyl hydroxypivalate, 1,4-cyclohexanedimethanol, 1,3-cyclohexanedimethanol, 1,2-cyclohexanedimethanol, tricyclodecanedimethanol, hydrogenated bisphenol A, hydrogenated bisphenol S, ethylene oxide and propylene oxide adducts of hydrogenated bisphenol A, ethylene oxide and propylene oxide adducts of bisphenol S, ethylene oxide and propylene oxide adducts of hydrogenated bisphenol S, 1,9-nonanediol, 2-methyloctanediol, 1,10-decanediol, 2-butyl-2-ethyl-1,3-propanediol, and tricyclodecanedimethanol. Examples of polyetherpolyols include polyethers such as polyethylene glycol, polypropylene glycol, and polytetramethylene glycol.

In terms of raw material availability and compatibility with the other components, preferred aromatic dicarboxylic acids include terephthalic acid and isophthalic acid, preferred aliphatic dicarboxylic acids include aliphatic dicarboxylic acids with 4 to 12 carbon atoms, particularly adipic acid, suberic acid, and sebacic acid, and preferred aliphatic diols include aliphatic diols with 2 to 12 carbon atoms, particularly ethylene glycol, propylene glycol, 1,3-propanediol, and neopentyl glycol.

Furthermore, polyvalent carboxylic acids such as trimellitic anhydride and pyromellitic dianhydride, hydroxycarboxylic acids such as 2,2-dimethyl-3-hydroxypropionic acid, polyvalent polyols such as trimethylolethane, trimethylolpropane, glycerol and pentaerythritol, and dicarboxylic acids or glycols containing a metal sulfonate group such as a metal salt of 5-sulfoisophthalic acid, 4-sulfonaphthalene-2-7-dicarboxylic acid, or 5[4-sulfophenoxyl]isophthalic acid, or a metal salt of 2-sulfo-1,4-butanediol or 2,5-dimethyl-3-sulfo-2,5-hexanediol can also be used in combination, provided their use does not impair the content of the present invention.

Commercially available products may be used as the aromatic dicarboxylic acid, the polyester resin synthesized from an aliphatic dicarboxylic acid and an aliphatic diol, and the polyester resin synthesized from an aromatic dicarboxylic acid and an aliphatic diol, and in terms of readily obtaining the desired coating characteristics, specific examples of preferred products include Byron 200, Byron 240, Byron 650, Byron GK 880, and Elitel XA-0611.

(Aromatic Ring Percentage of Polyester)

In order to acquire a favorable balance between plastic workability and surface hardness, the weight % of aromatic rings within the polyester resin used in the present invention (hereafter referred to as the aromatic ring percentage) is preferably within a range from 30 to 65 weight %, and more preferably from 35 to 60 weight %. The aromatic ring percentage (weight %) can be determined by NMR measurement.

(Tg of Non-Polymerizable Thermoplastic Resin (A))

The glass transition temperature (Tg) of an acrylic resin in the non-polymerizable thermoplastic resin (A) is preferably within a range from 50 to 150° C.

The glass transition temperature (Tg) of a polyester resin in the non-polymerizable thermoplastic resin (A) is preferably within a range from 5 to 100° C., more preferably from 10 to 80° C., and even more preferably within a range from 20 to 70° C.

(Quantity of Non-Polymerizable Thermoplastic Resin (A))

The quantity of the non-polymerizable thermoplastic resin (A) within the curable resin layer used in the present invention is preferably within a range from 30 to 70 weight %, and more preferably from 40 to 60 weight %.

(Radical Polymerizable Oligomer (B1))

For the curing reaction to proceed efficiently within the curable resin layer, the reactive groups are preferably able to move sufficiently freely within the matrix, and consequently the glass transition temperature of the radical polymerizable oligomer (B1) is preferably less than 0° C.

Preferably the radical polymerizable oligomer (B1) has 2 to 8 acryloyl groups or methacryloyl groups per molecule, as a radical reactive unsaturated group.

As the radical polymerizable oligomer (B1), urethane acrylates are preferred.

(Urethane Acrylate)

Urethane (meth)acrylates are (meth)acrylates that have a urethane linkage within the molecule. These can be obtained by reacting hydroxyl group-containing (meth)acrylates, polyisocyanates, and polyols, for example. Depending on the purpose, it may be possible to use a urethane (meth)acrylate formed from a hydroxyl group-containing (meth)acrylate and a polyisocyanate, without using a polyol as a raw material.

As the hydroxyl group-containing (meth)acrylate, hydroxyalkyl (meth)acrylates or ether extensions or lactone extensions thereof can be used, and for the various polyols, those with a structure in which a portion of the hydroxyl groups have been converted to a (meth)acrylate, and the various carboxylate esters of glycidyl (meth)acrylate and the like can be used. Specifically, hydroxyalkyl (meth)acrylates with 2 to 8 carbon atoms such as 2-hydroxyethyl (meth)acrylate and 4-hydroxybutyl (meth)acrylate, (poly)ethylene glycol mono(meth)acrylate, (poly)propylene glycol mono(meth)acrylate, poly(ethylene glycol-propylene glycol) mono(meth)acrylate, poly(propylene glycol-tetramethylene glycol) mono(meth)acrylate, ε-caprolactone extensions of 2-hydroxyethyl (meth)acrylate, as well as glycerol mono(meth)acrylate, glycerol di(meth)acrylate, pentaerythritol triacrylate, dipentaerythritol pentaacrylate, tris(2-hydroxyethyl)diacrylate and the like, and acid adducts of glycidyl (meth)acrylate using acetic acid, propionic acid, p-tert-butylbenzoic acid, and fatty acids and the like, can be used.

As the polyisocyanate used in the urethane acrylate, aromatic polyisocyanates, aliphatic polyisocyanates, cyclic aliphatic polyisocyanates, and polyisocyanates with an isocyanurate structure can be used. Specific examples include tolylene diisocyanate, xylylene diisocyanate, methylene diphenyl diisocyanate, naphthalene diisocyanate, isophorone diisocyanate, 2,2,4-trimethylhexamethylene diisocyanate, 1,6-hexanediol diisocyanate, hydrogenated xylylene diisocyanate, hydrogenated methylene diphenyl diisocyanate, dimer acid diisocyanate, lysine diisocyanate, as well as trimers of 1,6-hexanediol diisocyanate and isophorone diisocyanate which form an isocyanurate skeleton.

As the polyol used in the urethane acrylate, polyether polyols, polyester polyols, polycarbonate polyols, and polybutadiene polyols and the like can be used, and according to circumstances, a polyol that has been modified using a polysiloxane or a fluoroolefin copolymer or the like can also be used.

(Polyester Acrylate)

The polyester (meth)acrylate used in the present invention is a saturated or unsaturated polyester (meth)acrylate with at least two (meth)acryloyl groups per molecule.

Such a polyester (meth)acrylate can be obtained, for example, by the esterification of a polybasic acid or anhydride thereof, a polyol, and a (meth)acrylate or anhydride thereof. Depending on the purpose, it may be possible to use a polyester (meth)acrylate formed from a polyol and a (meth)acrylate or anhydride thereof, without using a polybasic acid or anhydride thereof. In addition, a polyester (meth)acrylate obtained by reacting the carboxyl groups of a polyester synthesized using ordinary methods with a (meth)acrylate having an epoxy group can also be used.

As the polybasic acid, aromatic polybasic acids, chain-like aliphatic polybasic acids, and cyclic aliphatic polybasic acids and the like can be used. As the polyol, alkylene polyols can be used, for example.

The polyester which is a structural component of the polyester acrylate used in the present invention is obtained by an ester reaction between a glycol component and a triol, and a dibasic acid and tribasic acid. In this case, if necessary, a monoepoxy compound or a polyepoxy compound may also be used in combination.

(Polyester Acrylate Raw Material: Glycol)

Examples of the glycol raw material for the polyester include:

alkylene glycols typified by ethylene glycol, propylene glycol, butylene glycol, neopentyl glycol, hexylene glycol, 1,3-butanediol, 1,4-butanediol, 1,5-pentanediol, 1,6-hexanediol, 2-methylpropane-1,3-diol, dimethylolcyclohexane, hydrogenated bisphenol A, and 2,4,4-trimethyl-1,3-pentanediol;

polyalkylene glycols typified by diethylene glycol, triethylene glycol, tetraethylene glycol, polyethylene glycol, dipropylene glycol, polypropylene glycol, and polybutylene glycol; and

addition reaction products of dihydric phenols typified by bisphenol A, bisphenol F, bisphenol S, and tetrabromobisphenol A, and alkylene oxides typified by ethylene oxide and propylene oxide.

Examples of triols include glycerol, trimethylolpropane, trimethylolethane, and 1,2,6-hexanetriol.

Tetraol units include pentaerythritol, diglycerol, and 1,2,3,4-butanetetraol.

Furthermore, as the glycol and a portion of the acid component, a polycondensate such as a polyethylene terephthalate having hydroxyl groups or carboxyl groups may also be used.

(Polyester Acrylate Raw Material: Acid Component)

Examples of dibasic acids (or anhydrides) include o-phthalic acid, tetrahydrophthalic anhydride, hexahydrophthalic anhydride, tetrachlorophthalic acid, tetrabromophthalic acid, malonic acid, succinic acid, adipic acid, azelaic acid, 1,1,2-dodecanoic acid, maleic acid, fumaric acid, itaconic acid, himic acid, and HET acid, examples of tribasic acid units include trimellitic acid, aconitic acid, butanetricarboxylic acid, and 6-carboxy-3-methyl-1,2,3,6-hexahydrophthalic acid, and examples of tetrabasic acid units include pyromellitic acid and butanetetracarboxylic acid.

Examples of α,β-unsaturated dibasic acids or acid anhydrides thereof include maleic acid, maleic anhydride, fumaric acid, itaconic acid, citraconic acid, chloromaleic acid, and esters thereof. Examples of aromatic saturated dibasic acids or acid anhydrides thereof include phthalic acid, phthalic anhydride, isophthalic acid, terephthalic acid, nitrophthalic acid, tetrahydrophthalic anhydride, endomethylenetetrahydrophthalic anhydride, halogenated phthalic anhydrides, and esters thereof, and examples of aliphatic or alicyclic saturated dibasic acids include oxalic acid, malonic acid, succinic acid, adipic acid, sebacic acid, azelaic acid, glutaric acid, hexahydrophthalic anhydride, and esters thereof, and these acids may be used individually or in combination.

(Monoepoxy Compound)

Examples of monoepoxy compounds include ethylene oxide, propylene oxide, epichlorohydrin, styrene oxide, and phenyl glycidyl ether. Furthermore, favorable examples of polyepoxy compounds are the so-called diepoxy compounds, examples of which include the epoxy resins listed on pages 19 through 48 of Lectures on Plastic Materials (1) “Epoxy resins” by Nikkan Kogyo Shimbun Ltd. (published 10 May 1969, compiled by Kuniyuki Hashimoto).

A commercially available product may be used as the polyester acrylate, specific examples of which include M-7100, M-8030, M-8060, M-8100, M-8530, M-8560, and M-9050 (trade names: all manufactured by Toagosei Co., Ltd.), and in terms of readily obtaining the desired balance of coating characteristics, preferred products include M-7100 and M-8530, which have a slightly larger molecular weight between crosslinks.

(Epoxy Acrylate)

An epoxy (meth)acrylate is a (meth)acrylate obtained by reacting a polyepoxide with (meth)acrylic acid or the anhydride thereof. Examples of suitable polyepoxides include bisphenol A type epoxy resin, bisphenol F type epoxy resin, phenol novolak type epoxy resin, and cresol novolak type epoxy resin, or bisphenol type epoxy resins in which the aromatic rings have been hydrogenated.

A preferred epoxy acrylate is bisphenol A type epoxy acrylate.

As the polyepoxide, an epoxy resin with an average of 2 to 5 epoxy groups per molecule is preferred. Of these epoxy resins, bisphenol type epoxy resins are preferred because of their ability to form a cured coating with an excellent balance between hardness and ductility. Furthermore, the polyepoxide can be used either alone, or in combinations of two or more different compounds.

The reaction between the polyepoxide and acrylic acid or methacrylic acid is normally performed at a temperature within a range from 50° C. to 150° C., for a period of 1 to 8 hours. A catalyst is preferably used during reaction. Specific examples of suitable catalysts include amines such as triethylamine, dimethylbutylamine, and tri-n-butylamine, quaternary ammonium salts such as tetramethylammonium salts, tetraethylammonium salts, tetrabutylammonium salts, and benzyltriethylammonium salts, quaternary phosphonium salts, phosphines such as triphenylphosphine, and imidazoles such as 2-methylimidazole and 2-ethyl-4-methylimidazole.

The reaction can be performed under a flow of air or the like according to circumstances, in order to suppress the polymerization reaction of the acrylic acid or methacrylic acid. In this case, an antioxidant such as 2,6-di-t-butyl-4-methylphenol may be used to prevent oxidation reactions due to the air.

A preferred epoxy acrylate is bisphenol A type epoxy acrylate. Commercially available epoxy acrylates may be used, specific examples of which include NK Oligo EA-1020, NK Ester A-B1206PE, NK Ester ABE-300, NK Ester A-BPE-4, NK Ester A-BPE-6, NK Ester A-BPE-10, NK Ester A-BPE-20, NK Ester A-BPE-30, NK-Ester BPE-80N, NK Ester BPE-100N, NK Ester BPE-500, NK Ester BPE-900, NK Ester BPE-1000N, NK Ester A-9300, NK Oligo EA-5220, NK Oligo EMA-5220, NK Oligo EA-5221, NK Oligo EA-5222, NK Oligo EA-5223, and NK Ester A-BPFL-4E (trade names: all manufactured by Shin-Nakamura Chemical Co., Ltd.), and in terms of the physical properties of the cured coating and also for economic reasons, EA-1020 is particularly suitable.

(Photopolymerization Initiator)

The curable resin layer may contain a conventional photopolymerization initiator or photosensitizer if required. Representative photopolymerization initiators include acetophenone-based compounds such as diethoxyacetophenone and 1-hydroxycyclohexyl-phenyl ketone, benzoin-based compounds such as benzoin and benzoin isopropyl ether, acylphosphine oxide-based compounds such as 2,4,6-trimethylbenzoindiphenylphosphine oxide, benzophenone-based compounds such as benzophenone, methyl o-benzoylbenzoate, and 4-phenylbenzophenone, thioxanthone-based compounds such as 2,4-dimethylthioxanthone, and aminobenzophenone-based compounds such as 4,4-diethylaminobenzophenone.

The quantity of the photopolymerization initiator is typically within a range from 0.5 to 15 weight %, and preferably from 1 to 8 weight %, relative to the active energy beam curable resin. Examples of suitable photosensitizers include amines such as triethanolamine and ethyl 4-dimethylaminobenzoate. In addition, onium salts such as benzylsulfonium salts, benzylpyridinium salts, and arylsulfonium salts are known as photocationic initiators, and these initiators can also be used, either alone or in combination with the photoradical generators mentioned above.

(Active Energy Beam)

The active energy beam refers to visible light, ultraviolet rays, electron beams, and gamma rays, any of which can be used, but ultraviolet rays is particularly preferred. Sources of ultraviolet rays include sunlight, low-pressure mercury lamps, high-pressure mercury lamps, ultra-high pressure mercury lamps, carbon arc lamps, metal halide lamps, and xenon lamps.

In the polymerization reaction, alcohols such as methanol, ethanol, propanol, butanol, ethylene glycol, methyl cellosolve, and ethyl cellosolve, esters such as methyl cellosolve acetate and ethyl cellosolve acetate, ketones such as methyl ethyl ketone and methyl isobutyl ketone, and aromatic compounds such as benzene, toluene, chlorobenzene and dichlorobenzene can be used as the reaction solvent. In the polymerization reaction, hydroquinone, methylhydroquinone, hydroquinone monomethyl ether, 4-methylquinoline, or phenothiazine or the like may be introduced into the reaction system as a polymerization inhibitor.

In a preferred combination, the non-polymerizable thermoplastic resin (A) is an acrylic resin, and the radical polymerizable oligomer (B1) is a urethane acrylate.

In another preferred combination, the non-polymerizable thermoplastic resin (A) is a polyester resin, and the radical polymerizable oligomer (B1) is a polyester acrylate.

(Weight Ratio P Between Non-Polymerizable Thermoplastic Resin (A) and Radical Polymerizable Oligomer (B1))

The weight ratio P of the radical polymerizable oligomer (B1) relative to the non-polymerizable thermoplastic resin (A) in the present invention is preferably within a range from 30/70 to 70/30, more preferably from 40/60 to 70/30, and most preferably from 40/60 to 60/40.

A range from 30/70 to 60/40 is preferred in cases where the drying property of the film coating is of greater importance, or the coating is a thin film with a thickness of no more than 10 μm thick, such as when the film coating is formed using a printing device such as a gravure printing process or the like. To enhance the drying property even further, a polyacrylate with a weight average molecular weight of 150,000 or greater or a polyester with a weight average molecular weight of 30,000 or greater is preferably used as the non-polymerizable thermoplastic resin.

In cases where the decorative layer is transferred onto the curable resin layer by using dry lamination to bond the curable resin layer to the decorative layer provided on the substrate film, cases where adequate drying time can be ensured such as when using a coating machine, and cases where activation is a greater issue such as when providing a thick film coating of at least 10 μm, the weight ratio P of the radical polymerizable oligomer (B1) relative to the non-polymerizable thermoplastic resin (A) is preferably within a range from 40/60 to 70/30, and more preferably from 40/60 to 60/40.

Furthermore, the combined weight % of the non-polymerizable thermoplastic resin (A) and the radical polymerizable oligomer (B1) within the curable resin layer is preferably 60 weight % or greater.

As the film thickness of the curable resin layer increases, the protection effect on the obtained molded product also increases, and the curable resin layer is better able to absorb the surface irregularities of the decorative layer, giving the molded product excellent luster. Accordingly, the film thickness of the curable resin layer is preferably at least 3 μm, and more preferably at least 15 μm. If the thickness of the curable resin layer exceeds 200 μm, it is difficult to achieve adequate activation of the curable resin layer with the organic solvent. In terms of achieving adequate activation of the curable resin layer with the organic solvent, achieving favorable performance as a protective layer for the decorative layer, and absorbing the irregularities in the decorative layer, the dry film thickness of the curable resin layer is preferably within a range from 3 to 200 μm, and more preferably from 15 to 70 μm.

(Radical Polymerizable Compound (B2))

A low molecular weight radical polymerizable compound (B2) with a weight average molecular weight of at least 200 but less than 700 may be added to the curable resin layer. The low molecular weight radical polymerizable compound (B2) moves more readily within the curable resin layer than the radical polymerizable oligomer (B1), and is therefore used effectively in situations when a stronger cured film coating must be obtained. However, if the quantity of the radical polymerizable compound (B2) added is too great, the film coating tends to bleed out and seep into the decorative layer, and cause film thickness variation in the film coating, and consequently the quantity added of the low molecular weight radical polymerizable compound (B2) should preferably not exceed 20 weight % of the radical polymerizable compounds.

The low molecular weight radical polymerizable compound (B2) with a weight average molecular weight of at least 200 but less than 700 can be selected appropriately from the various conventional vinyl monomers, according to the characteristics required.

Preferred examples include the various (meth)acrylates, as well as allyl ethers, and unsaturated carboxylate esters, and in terms of curability, acrylates are even more preferred. Furthermore, the number of radical polymerizable unsaturated groups within these compounds is typically at least one group per molecule, and preferably from 2 to 6 groups per molecule.

Examples of these compounds include 1,6-hexanediol di(meth)acrylate, 1,9-nonanediol di(meth)acrylate, neopentyl glycol di(meth)acrylate, glycerol di(meth)acrylate, neopentyl glycol hydroxypivalate diacrylate, polyethylene glycol di(meth)acrylate, polypropylene glycol di(meth)acrylate, polytetramethylene glycol di(meth)acrylate, epichlorohydrin-modified polypropylene glycol diacrylate, ethylene oxide-modified bisphenol A di(meth)acrylate, tris(2-hydroxyethyl)isocyanurate diacrylate, glycerol tri(meth)acrylate, ethylene oxide-extended glycerol tri(meth)acrylate, propylene oxide-extended glycerol tri(meth)acrylate, trimethylolpropane tri(meth)acrylate, ethylene oxide-extended trimethylolpropane triacrylate, propylene oxide-extended trimethylolpropane triacrylate, mixtures of pentaerythritol triacrylate and pentaerythritol tetraacrylate, and dipentaerythritol hexa(meth)acrylate. Of these, mixtures of pentaerythritol triacrylate and pentaerythritol tetraacrylate are preferred.

(Microparticles A within Curable Resin Layer)

In order to achieve a swelling inhibiting effect for the curable resin layer as a result of activation, and give the layer a matte finish, the curable resin layer can also contain inorganic or organic microparticles (hereafter referred to as the microparticles A).

The curable resin layer is preferably transparent, so that when the decorative layer is laminated, the design characteristics of the decorative layer of the resulting hydraulically transferred body manifest clearly. However, although dependent on the characteristics required of the hydraulically transferred body and the nature of the pattern, generally the curable resin layer need not be completely transparent, and may be within a range from transparent to semitransparent, provided that the color and design of the decorative layer of the obtained hydraulically transferred body can be seen through the curable resin layer. Furthermore, the curable resin layer may also be colored.

Examples of suitable inorganic microparticles include inorganic pigments, including inorganic color pigments such as carbon, titanium oxide, graphite, and zinc oxide, and inorganic extenders such as calcium carbonate powder, precipitated calcium carbonate, gypsum, clay (China Clay), silica powder, diatomaceous earth, talc, kaolin, alumina white, barium sulfate, aluminum stearate, magnesium carbonate, baryta powder, and polishing powder; as well as silicone and glass beads.

Examples of suitable organic microparticles include organic color pigments, organic crystals and polymer microparticles. Examples of organic color pigments include general purpose pigments such as azo pigments, phthalocyanine pigments, indanthrene pigments, and quinacridone pigments. Because the particle size or the amount of the organic color pigment affect the hiding effect on the decorative layer in the transfer layer, or if there is no decorative layer the hiding effect on the substrate (the transfer backing), the particle size or the amount of the organic color pigment should be controlled in a manner that suits the design purpose.

Examples of suitable organic crystals include crystalline polyureas, crystalline polyurethanes, crystalline polyamides, crystalline amino acids, crystalline polypeptides, and crystalline organometallic complexes.

Furthermore, examples of suitable polymer powders include cross-linked acrylic microparticles, cross-linked polystyrene resin microparticles, cross-linked urethane microparticles, phenol resin microparticles, silicone resin microparticles, polyethylene microparticles, fluororesin microparticles, melamine microparticles, polycarbonate microparticles and phenol microparticles.

Of the above microparticles A, inorganic pigments, organic crystals, and polymer particles are preferred for their strong swelling inhibiting effect, and inorganic extenders and organic crystals exhibit a particularly strong effect, and are consequently particularly preferred.

(Decorative Layer)

The printed ink or coating used as the decorative layer provided on top of the curable resin layer is preferably activated by the organic solvent and softened sufficiently to effect transfer, and formation of the decorative layer by printing using gravure printing ink after the curable resin layer has dried is particularly desirable.

As the base resin used in the printed ink or coating, thermoplastic resins such as acrylic resins, polyurethane resins, polyamide resins, urea resins, epoxy resins, polyester resins, vinyl resins (vinyl chloride resins, vinyl acetate resins, and vinyl chloride-vinyl acetate copolymer resins), vinylidene resins (vinylidene chloride, vinylidene fluonate), ethylene-vinyl acetate resins, polyolefin resins, chlorinated olefin resins, ethylene-acrylic resins, petroleum-based resins, and cellulose-derivative resins can be used, of which polyurethane resins, polyester resins, and vinyl chloride-vinyl acetate copolymer resins are preferred for their excellent solubility in organic solvents, fluidity, pigment dispersibility, and transferability, and polyurethane resins are particularly preferred.

Pigments are preferred as the colorant used within the printed ink or coating, and either organic or inorganic pigments can be used. Furthermore, a metallic gloss ink containing as a pigment, metal flecks obtained from a paste of metal cutting particles or an evaporated metal film can also be used. Preferred metals include aluminum (Al), gold (Au), silver (Ag), brass (Cu—Zn), titanium (Ti), chrome (Cr), nickel (Ni), nickel chrome (Ni—Cr), and stainless steel (SUS). These metal flecks may also be subjected to surface treatment with an epoxy resin, polyurethane, acrylic resin, or cellulose derivative such as nitrocellulose, in order to enhance dispersibility, oxidation resistance, and the strength of the ink layer.

The decorative layer can be laminated to the film for hydraulic transfer by either

1) a method in which the decorative layer is applied or printed onto the curable resin layer on top of the supporting body, or

2) a method in which a film having the curable resin layer formed on the supporting film is dry laminated to a film having the decorative layer formed on a release film.

When coating or printing the decorative layer onto the curable resin layer on top of the supporting body as in method 1) above, some adjustments to properties such as the wettability of the curable resin layer surface are required depending on whether the decorative layer is to be coated or printed.

When the decorative layer is formed in advance on a release film as in method 2) above, lamination is preferably performed by dry laminating the film having the decorative layer formed on a release film onto the film having the curable resin layer formed on the supporting film.

In the step of bonding the film in which the curable resin layer is provided on top of a supporting body to the film in which the decorative layer is provided on top of a release film, because supporting films like PVA films typically have low heat resistance, problems can occur if the films are bonded together at temperatures exceeding 130° C., including shrinkage of the film or laminate wrinkles, the drying and bonding of the film (A) by hot pressing is preferably performed within a temperature range from 40 to 120° C., and more preferably from 40 to 100° C.

The decorative layer can be formed on the release film or the curable resin layer formed on the supporting film not only by gravure printing, but also by other techniques such as offset printing, screen printing, inkjet printing, and thermal transfer printing. The dry film thickness of the decorative layer is preferably within a range from 0.5 to 15 μm, and more preferably from 1 to 7 μm. Furthermore, unpatterned colored layers and colorless varnish resin layers can also be formed by a coating process.

Various commonly used additives can be added to the curable resin layer and the decorative layer, including antifoaming agents, sedimentation inhibitors, pigment dispersants, fluidity modifiers, blocking inhibitors, lubricants, antistatic agents, antioxidants, photostabilizers, ultraviolet absorbers, silica sols, and organosilica sols, provided their use does not impair the design freedom or spreadability of the layer. These additives can be in liquid or solid form, and may be either dissolved or simply dispersed.

In cases where the adhesive strength between the curable resin layer and the decorative layer is inadequate, such as when the addition of the microparticles A weakens the adhesive strength between the film (X) and the film (Y), causing the layers to detach at the interface between the curable resin layer and the decorative layer when the release film is removed, an adhesion layer is preferably provided on the curable resin layer after the curable resin layer, which forms a matte finish, is provided on the supporting film, in order to improve the adhesiveness with the decorative layer. Preferred adhesive layers are curable resin layers that do not contain a matting agent, or resin layers produced by eliminating the colorant from the ink layer or coating layer used as the decorative layer. In this case, the films should be bonded together by dry lamination (dry lamination method), with the films arranged so that the adhesive layer of the film (X) and the decorative layer of the film (Y) are facing each other.

The production of the film for hydraulic transfer of the present invention is preferably performed using a dry laminator. In other words, the supporting body is loaded onto one of the supply rolls of the dry laminator (a first supply roll), and the film (Y), composed of a release film onto which the patterned decorative layer has been printed, is loaded onto the other supply roll (a second supply roll). An organic solvent solution of an aforementioned curable resin is then applied to the surface of the water-soluble or water-swelling resin layer of the supporting film supplied from the first supply roll, and the resulting product is dried in a dryer, thereby obtaining the film (X) having the curable resin layer formed on top of the supporting film. The films are then superposed so that the curable resin layer of the film (X) and the decorative layer of the film (Y) supplied from the second supply roll face each other, the layers are bonded together using hot press rollers, and the resulting product is then wound onto a take-up roll, thereby producing the film for hydraulic transfer of the present invention.

Devices that can be used to apply the organic solvent solution of the curable resin to the supporting film include slit reverse coaters, die coaters, comma coaters, bar coaters, knife coaters, gravure coaters, gravure reverse coaters, micro-gravure coaters, flexo coaters, blanket coaters, roll coaters, or air knife coaters.

Furthermore, because the supporting body laminating onto a release film provides a coating or printing substrate that suffers almost no sagging and demonstrates good dimensional stability, the film thickness of the coating of the organic solvent solution of the curable resin can be precisely controlled.

The production of the film (Y) having the decorative layer formed on top of a release film can be achieved by a coating process, but a printing process is preferred, and particularly when printing a pattern, gravure printing, flexo printing, offset printing and silk printing are particularly preferred. After coating or printing the decorative layer onto the release film, the resulting product is dried to obtain the film (Y).

(Release Film)

Examples of suitable release films that can be used in the present invention include polyolefin-based films such as polypropylene and polyethylene films, polyester films, and films composed of nylon or polyvinyl chloride, and polyolefin-based films are particularly preferred for their relatively low cost and recyclability. In terms of obtaining the appropriate adhesion to the decorative layer, and ensuring adequate strength during printing, the thickness of the film is preferably within a range from 0.5 μm to 250 μm.

Furthermore, if required, the maximum peel strength of the release film may be further adjusted by subjecting the release film to surface treatment.

The film for hydraulic transfer of the present invention can be hydraulically transferred by using the same methods used to hydraulically transfer conventional films for hydraulic transfer.

(Method of Producing Hydraulically Transferred Body)

In the present invention, the method of producing a molded product having either a curable resin layer or both a decorative layer and a curable resin layer is similar to methods used with conventional films for hydraulic transfer, in that the film for hydraulic transfer of the present invention is floated on water with the supporting film facing downward, the transfer layer containing either the curable resin layer or both the decorative layer and the curable resin layer is activated by an organic solvent, the transfer layer is hydraulically transferred onto the transfer target body, the supporting film is removed, and the transfer layer is then cured by irradiation with an active energy beam. An overview of a method of producing a decorative molded body using a film for hydraulic transfer is described below.

(1) The film for hydraulic transfer is floated on water in a tank with the supporting film facing downward and the transfer layer facing upward, and the supporting film is dissolved or swelled in the water.

(2) The transfer layer composed of the curable resin layer and the decorative layer is activated by coating or spraying an activator onto the transfer layer of the film for hydraulic transfer.

Alternatively, the transfer layer may be activated by an organic solvent before the film is floated in water.

(3) The transfer target body and the film for hydraulic transfer are gradually submerged in the water by pushing the transfer target body down onto the transfer layer of the film for hydraulic transfer, and the transfer layer is transferred by adhering firmly to the transfer target body due to hydraulic pressure.

(4) The transfer target body is taken out of the water, the supporting film is removed, and the curable resin layer of the transfer layer that has been transferred to the transfer target body is cured by irradiation with an active energy beam, thereby obtaining a molded product having either a cured resin layer, or a cured resin layer and a decorative layer.

The transfer layer of the film for hydraulic transfer of the present invention, composed of either a curable resin layer or a curable resin layer and a decorative layer, is activated by coating or spraying an organic solvent onto the layer, thereby sufficiently solubilizing or softening the layer. Activation in this context refers to improving the shape followability and adhesion of the transfer layer to the transfer target body, by imparting the transfer layer with greater flexibility by coating or spraying the transfer layer with an organic solvent, thereby solubilizing the layer without completely dissolving it. The extent of this activation should be such that when the transfer layer is transferred from the film for hydraulic transfer to the transfer target body, the transfer layer is softened sufficiently to conform to the shape of the three-dimensional curved surface of the transfer target body.

The water in the tank used in the hydraulic transfer process swells or dissolves the supporting film, and also acts as the hydraulic medium which causes the film for hydraulic transfer to adhere to the three-dimensional surface of the transfer target body during transfer of the transfer layer. Specific examples of the water include tap water, distilled water, and ion exchange water, and depending on the type of supporting film used, a solution in which up to 10% of an inorganic salt of boric acid or the like or an alcohol has been dissolved in the water may also be used.

(Activator)

The activator is an organic solvent that imparts flexibility by solubilizing either the curable resin layer or the curable resin layer and decorative layer. The activator preferably does not evaporate before the hydraulic transfer process is complete. Activators typically used in hydraulic transfer can be used as the activator in the present invention. Specific examples include toluene, xylene, ethylbenzene, hexane, cyclohexane, methyl ethyl ketone, methyl isobutyl ketone, ethyl acetate, butyl acetate, propyl acetate, isobutyl acetate, 1-propanol, 2-propanol, 1-butanol, 2-butanol, ethyl cellosolve, cellosolve acetate, butyl cellosolve, carbitol, carbitol acetate, butyl carbitol acetate, Solfit acetate, and mixtures thereof.

In order to enhance the adhesion between the printed ink or coating and the molded body, a small quantity of a resin component may be incorporated within the activator. The adhesion can be enhanced by including from 1 to 10% of a resin having a structure resembling an ink binder, such as a polyurethane, acrylic resin, or epoxy resin.

To achieve the same object, the radical polymerizable compound or photopolymerization initiator described above may also be dissolved within the activator.

After the transfer layer has been hydraulically transferred to the transfer target body, the supporting film is removed either by dissolution in the water or peeling, and the resulting product is then dried. In a manner similar to a conventional hydraulic transfer method, the supporting film is dissolved or peeled off in a stream of water.

After the water and the activator have dried, the curable resin layer is cured by irradiation with an active energy beam. The curing time depends on the composition and the type of curing agent, but in terms of the overall process, curing preferably takes from several minutes to one hour.

(Molded Product that Functions as the Target Transfer Body)

The curable resin layer or decorative layer can preferably sufficiently adhere to the surface of the molded product that acts as the transfer target body, and for this reason, a primer layer may be provided on the surface of the molded product if required. There are no particular restrictions on the resin used for forming the primer layer, and any of the resins conventionally used as primer layers are suitable, including urethane resins, epoxy resins, and acrylic resins. Furthermore, molded products formed from a resin component with high solvent absorption, such as ABS resin or SBS rubber which have good adhesion, do not need a primer. There are no particular restrictions on the material used to produce the molded product, and suitable materials include metal, plastic, wood, pulp mold, or glass, provided that an adequate level of waterproofness can be ensured after treatment with a primer, so that quality problems such as collapse of the molded product shape do not occur when submerged in water.

Specific examples of molded products to which the present invention can be applied include household electric appliances such as televisions, video recorders, air conditioners, radio cassette players, mobile phones, and refrigerators, OA equipment such as personal computers and printers, and the housings of household products such as oil fan heaters and cameras. Furthermore, the present invention can be widely used in a variety of fields, and is of particular advantage when used with molded products that have curved surfaces and require design freedom, including furniture such as tables, wardrobes, and columns, building components such as bathtubs, component kitchens, doors, window frames, and crown moldings, sundries such as writing implements, electronic calculators, PDAs, and cases, as well as stationery, interior panels for automobiles, exterior panels for automobiles and motorcycles, hubcaps, ski carriers, carrier bags for fixing to automobiles, golf clubs, marine parts for yachts and the like, skis, snowboards, helmets, goggles, and monuments.

### EXAMPLES

As follows is a description of specifics of the present invention using a series of examples, although the present invention is in no way limited by these examples. The units “parts” and “%” are by weight unless otherwise specified.

### Production Example 1

Using a printing ink G1 with the composition shown below, a woodgrain pattern was gravure printed onto the surface of an unstretched polypropylene film of thickness 30 μm (“Pylen CT” manufactured by Toyobo Co., Ltd.) using two solid plates and three pattern plates, thereby producing a printed film P1.

<Composition of Ink G1, Black, Brown, White>

Burnock EZL676: 20 parts by weight (solid fraction equivalent)

Pigments (black, brown, white): 10 parts by weight (solid fraction)

Additives such as waxes: 10 parts by weight

Solvent: added to adjust the nonvolatile fraction to 30%

“Burnock EZL676” is a polyurethane manufactured by Dainippon Ink and Chemicals, Inc., and the solvent used was a mixture of toluene, ethyl acetate, and methyl ethyl ketone in a ratio of 2:1:1.

### Production Example 2

Pattern print and solid print with a thickness of 4 g (solid fraction)/m² was gravure printed onto the surface of a 50 μm thick unstretched polypropylene film (“Pylen CT” manufactured by Toyobo Co., Ltd.) by using three plates and a printing ink G2 with the composition shown below, thereby producing a printed film P2 displaying a lattice pattern.

<Composition of Ink G2, Black, Yellow, White>

Polyurethane (product name “Burnock EZL676”, manufactured by Dainippon Ink and Chemicals, Inc.,): 20 parts by weight

Pigments (black, yellow, white): 10 parts by weight

Ethyl acetate-toluene (1/1): 60 parts by weight

Additives such as waxes: 10 parts by weight

### Example 1

Solid print with a curable resin layer of a thickness of 10 g (solid fraction)/m² was gravure printed onto the surface of a polyvinyl alcohol resin film with a thickness of 35 μm by using two plates and a curable resin composition (1) with the formulation described below, and pattern print and solid print with thickness of 3 to 4 g (solid fraction)/m² were printed by using three plates and a printing ink with the formulation described below.

(Curable Resin Composition (1))

Unidic 17-813: 50 parts by weight (solid fraction equivalent)

Acrypet VH: 50 parts by weight

Irgacure 184: 1 part by weight

Solvent: added to adjust the nonvolatile fraction to 30 weight %

“Unidic 17-813” is a polyurethane poly(meth)acrylate manufactured by Dainippon Ink and Chemicals, Inc. (weight average molecular weight: 1,500, Tg: −20° C. (DSC method)), “Acrypet VH” is a non-polymerizable thermoplastic acrylic resin manufactured by Mitsubishi Rayon Co., Ltd. (weight average molecular weight: 200,000, Tg: 100° C.), “Irgacure 184” is a photopolymerization initiator manufactured by Ciba Specialty Chemicals Co., Ltd., and the solvent used was a mixed solvent of MEK, butyl acetate, toluene, and ethyl acetate.

<Ink Composition, Black, Brown, White>

Polyurethane (product name “Burnock EZL676, manufactured by Dainippon Ink and Chemicals, Inc.)”: 20 parts by weight

Pigments (black, brown, white): 10 parts by weight

Ethyl acetate-toluene (1/1): 60 parts by weight

Additives such as waxes: 10 parts by weight

The obtained film for hydraulic transfer C1 was placed in a water bath at 30° C. with the decorative layer facing upwards and left for two minutes, and then 40 g/m² of an activator (xylene/methyl isobutyl ketone/3-methyl-3-methoxybutyl acetate/butyl acetate=50/25/15/10: (hereafter referred to as the activator S)) was sprayed onto the film. After waiting a further 10 seconds, a molded product made of ABS resin (an interior panel for an automobile) was pushed down in the vertical direction, thereby transferring the pattern. After the transfer was completed, the molded product was washed in water and dried for one minute at 90° C. The sample was then passed three times through a UV irradiation device (output 80 KW/m, conveyor speed 10 m/minute), yielding a glossy cured film.

### Example 2

A film was produced by using a lip coater to coat a PVA film of thickness 30 μm (manufactured by Aicello Chemical Co., Ltd.) with a curable resin composition (2) described below in sufficient quantity to generate a film thickness of 20 μm when solid, and then drying the resulting film for two minutes at 60° C. The curable resin layer of this film and the decorative layer of the printed film P1 created in the production example 1 were positioned facing each other, and were then laminated together at 60° C. The laminated film was then wound, as is, thereby producing a film for hydraulic transfer C2.

The obtained film for hydraulic transfer was then floated in a water bath at 30° C. with the ink surface facing upwards and left for two minutes, and then 40 g/m² of the activator S was sprayed onto the film.

After leaving the film for a further 10 seconds, the decorative layer was hydraulically transferred in the vertical direction onto an automobile door panel made of a primer-coated ABS resin. After the transfer was completed, the transfer target body was washed in water and dried for 20 minutes at 90° C.

The sample was then passed once through a UV irradiation device (output 160 W/cm, conveyor speed 5 m/minute), yielding a glossy cured film.

(Curable Resin Composition (2))

Unidic 17-813: 60 parts by weight (solid fraction equivalent)

Paraloid A11: 20 parts by weight (solid fraction)

Paraloid B60: 20 parts by weight (solid fraction)

Irgacure 184: 3 parts by weight (solid fraction)

Solvent: (added to adjust the nonvolatile fraction to 50 weight %)

“Paraloid A11” is a non-polymerizable thermoplastic acrylic resin manufactured by Rohm and Haas Company (weight average molecular weight: 125,000, Tg: 100° C.), and “Paraloid B60” is a non-polymerizable thermoplastic acrylic resin manufactured by Rohm and Haas Company (weight average molecular weight: 50,000, Tg: 75° C.). The solvent used was a mixed solvent of MEK, butyl acetate, toluene, and ethyl acetate.

### Example 3

After forming a curable resin layer by coating a PVA film with a curable resin compound (3) in the same manner as the example 2, a decorative film was laminated thereon to form a decorative layer on top of the curable resin layer. The thus obtained film for hydraulic transfer C3 was then hydraulically transferred onto an automobile door panel made of ABS resin in the same manner as in the example 2, yielding a glossy cured film.

(Curable Resin Composition (3))

New Frontier R-2402: 50 parts by weight (solid fraction equivalent)

Aronix M-305: 10 parts by weight (solid fraction equivalent)

Paraloid A11: 40 parts by weight (solid fraction)

Irgacure 184: 3 parts by weight (solid fraction)

Solvent: (added to adjust the nonvolatile fraction to 50%)

“New Frontier R-2402” is a polyester acrylate manufactured by Dai-ichi Kogyo Seiyaku Co., Ltd. (weight average molecular weight: 1,590, Tg: −45° C.), and Aronix M-305 is a polyester acrylate manufactured by Toagosei Co., Ltd. (weight average molecular weight: 350, Tg: −49° C.).

### Example 4

After forming a layer of a curable resin layer composition (4) on a PVA film in the same manner as the example 2, a decorative film was laminated thereon to form a decorative layer on top of the curable resin layer. The thus obtained film for hydraulic transfer C4 was hydraulically transferred onto an automobile door panel made of ABS resin in the same manner as in the example 2, yielding a glossy cured film.

(Curable Resin Layer Composition (4))

Unidic V5500: 70 parts by weight (solid fraction equivalent)

Paraloid A11: 30 parts by weight (solid fraction)

Irgacure 184: 3 parts by weight (solid fraction)

Solvent: (added to adjust the nonvolatile fraction to 50 weight %)

“Unidic V5500” is a bifunctional epoxy acrylate manufactured by Dainippon Ink and Chemicals, Inc. (weight average molecular weight: 1,070, Tg: −4° C.).

### Example 5

After forming a layer of a curable resin layer composition (5) on a PVA film in the same manner as the example 2, a decorative film was laminated thereon, thereby forming a decorative layer on the curable resin layer.

The thus obtained film for hydraulic transfer C5 was then hydraulically transferred onto an automobile door panel made of ABS resin in the same manner as in the example 2, yielding a glossy cured film.

(Curable Resin Layer Composition (5))

Unidic V5500: 30 parts by weight (solid fraction equivalent)

Paraloid A11: 30 parts by weight (solid fraction)

Paraloid B60: 40 parts by weight (solid fraction)

Irgacure 184: 3 parts by weight (solid fraction)

Solvent: (added to adjust the nonvolatile fraction to 50 weight %)

### Example 6

Using a lip coater and the same method as the example 2, a curable resin composition (6) with the composition shown below was applied to a PVA film of thickness 30 μm in sufficient quantity to generate a dried film thickness of 40 μm, and the applied film was then dried for 3 minutes at 60° C. The curable resin layer of the resulting curable resin composition-coated film, and the printed layer of the film P2 having a lattice pattern generated in the production example 2 were positioned facing each other, and were then laminated together at 60° C., thereby yielding a film for hydraulic transfer C6 with a release sheet that had been aged for 96 hours at a temperature of 30° C. and a humidity of 50%.

(Curable Resin Composition (6))

NK Oligo EA-1020: 40 parts by weight (solid fraction)

M-8530: 10 parts by weight (solid fraction)

Byron GK 880: 50 parts by weight (solid fraction)

Toluene: 60 parts by weight

Methyl ethyl ketone: 55 parts by weight

Irgacure 184: 3 parts by weight

“NK Oligo EA-1020” is an epoxy acrylate manufactured by Shin-Nakamura Chemical Co., Ltd. (weight average molecular weight: 980, Tg: −7° C.), “M-8530” is a polyester acrylate manufactured by Toagosei Co., Ltd. (weight average molecular weight: 1,200, Tg: −62° C.), and “Byron GK 880” is a polyester resin manufactured by Toyobo Co., Ltd. (weight average molecular weight: 54,000, Tg: 84° C.).

After removing the PP film, the obtained film for hydraulic transfer C6 was placed in a water bath at 30° C. for one minute with the coated surface facing upwards, and 50 g/m² of the activator S was sprayed onto the film. After leaving the film for a further 20 seconds, a molded product (a housing for an oil fan heater) made of galvanized steel and coated with primer was pushed down in the vertical direction, thereby hydraulically transferring the transfer layer. After the transfer was completed, the molded product was washed in water, and then dried for 30 minutes at 120° C. Next, the curable resin layer was completely cured by passing the sample once through a UV irradiation device (equivalent UV dose 2400 mJ/m²), thereby obtaining a hydraulically transferred body having excellent surface luster and a vibrant pattern.

### Example 7

Using a lip coater and the same method as the example 2, a curable resin composition (7) with the composition shown below was applied to a PVA film of thickness 30 μm in sufficient quantity to generate a dried film thickness of 40 μm, and the applied film was then dried for 3 minutes at 60° C. The curable resin layer of the resulting curable resin composition-coated film, and the printed layer of the film P2 having a lattice pattern produced in the production example 2 were positioned facing each other, and were then laminated together at 60° C., thereby yielding a film for hydraulic transfer C7 with a release sheet that had been aged for 96 hours at a temperature of 30° C. and a humidity of 50%.

(Curable Resin Composition (7))

NK Oligo EA-1020: 25 parts by weight (solid fraction)

M-8530: 25 parts by weight (solid fraction)

Byron GK 880: 25 parts by weight (solid fraction)

Byron 650: 25 parts by weight (solid fraction)

Toluene: 130 parts by weight

Methyl ethyl ketone: 130 parts by weight

Irgacure 184: 4 parts by weight
{Polyester resin/curable resin layer}×100=50 weight %, aromatic ring percentage Q=51 weight %

“Byron 650” is a polyester resin manufactured by Toyobo Co., Ltd. (weight average molecular weight: 51,000, Tg: 10° C.).

Using the obtained film for hydraulic transfer C7, hydraulic transfer was performed in the same manner as in the example 6, thereby yielding a hydraulically transferred body having excellent surface luster and a vibrant pattern. An Erichsen test was carried out on the hydraulically transferred body sample (fixed distance method, JIS-K5400), and an examination and evaluation of the surface of the sample after pressing with a 5 mm steel ball showed no cracking or peeling.

### Comparative Example 1

Solid print with a curable resin layer of a thickness of 10 g (solid fraction)/m² was gravure printed onto the surface of a polyvinyl alcohol resin film of thickness 35 μm by using two plates and a curable resin composition with the composition shown below, and pattern print and solid print with a thickness of 4 g (solid fraction)/m² were printed by using three plates and a printing ink with the formulation shown below.

(Curable Resin Composition (8))

Radical reactive acrylic resin (a): 97 parts by weight (solid fraction equivalent)

Irgacure 184: 3 parts by weight (solid fraction)

Solvent: (added to adjust the nonvolatile fraction to 28 weight %)

The radical reactive acrylic resin (a) is an active energy beam curable resin with a Tg of 85° C. having methacrylic group side chains, produced by first dissolving a poly(meth)acrylate (weight average molecular weight 105,000), produced by copolymerizing methyl methacrylate, ethyl acrylate, butyl acrylate, and hydroxyethyl methacrylate in a molar ratio of 40/10/10/20, in toluene to produce a 30% solution, and then adding 10 parts by weight of an acrylic isocyanate monomer MOI manufactured by Showa Denko K.K. and stirring for one hour at 50° C.

<Ink Composition, Black, Brown, White>

Polyurethane (product name “Burnock EZL676”, manufactured by Dainippon Ink and Chemicals, Inc.): 20 parts by weight

Pigments (black, brown, white): 10 parts by weight

Ethyl acetate-toluene (1/1): 60 parts by weight

Additives such as waxes: 10 parts by weight

When the obtained film for hydraulic transfer C8 was placed in a water bath at 30° C. for two minutes with the ink surface facing upwards, and the film was then sprayed with 50 g/m² of the activator S, although the ink coating film dissolved, the curable resin layer underwent almost no dissolution, and favorable hydraulic transfer could not be achieved.

### Comparative Example 2

After forming a layer of a curable resin composition (9) on a PVA film in the same manner as in the example 2, a decorative film was laminated thereon, thereby forming a decorative layer on the curable resin layer. However, after several days wrinkles appeared in the curable resin layer of the obtained film for hydraulic transfer, rendering it unusable. In terms of hydraulic transferability, because the curable resin layer dissolved quickly and did not balance well with the solubility of the ink, the pattern of the decorative layer was deformed, and a satisfactory transferred product could not be obtained.

(Curable Resin Composition (9))

Beamset 700: 100 parts by weight (solid fraction equivalent)

Irgacure 184: 3 parts by weight

Solvent: (added to adjust the nonvolatile fraction to 30 weight %)

Beamset 700 is a polyacrylate manufactured by Arakawa Chemical Industries, Ltd. (weight average molecular weight: 570, liquid form).

### Comparative Example 3

After forming a layer of a curable resin composition (10) on a PVA film in the same manner as in the example 2, the curable resin layer of this film and the printed layer of the film P2 having a lattice pattern produced in the production example 2 were positioned facing each other, and were then laminated together at 60° C., thereby forming a decorative layer on the curable resin layer.

(Curable Resin Layer Compound (10))

Unidic 17-813: 20 parts by weight (solid fraction equivalent)

Paraloid B-72: 80 parts by weight

Irgacure 184: 1 part by weight

Solvent: added to adjust the nonvolatile fraction to 30 weight %

“Paraloid B-72” is a non-polymerizable thermoplastic acrylic resin manufactured by Rohm and Haas Company (weight average molecular weight: 25,000).

The PP film could not be easily removed from the obtained hydraulic transfer sheet C10, and wrinkles appeared in the film. An evaluation of the molded product obtained after hydraulic transfer had been performed revealed a pencil hardness of 3B or lower, and the solvent resistance was also inferior.

### Comparative Example 4

After forming a layer of a curable resin composition (11) on a PVA film in the same manner as in the example 2, the curable resin layer of the film and the printed layer of the film P2 having a lattice pattern produced in production example 2 were positioned facing each other, and were then laminated together at 60° C., thereby forming a decorative layer on the curable resin layer.

(Curable Resin Layer Composition (11))

Unidic 17-813: 80 parts by weight (solid fraction equivalent)

Dianal ER-55: 20 parts by weight

Irgacure 184: 1 part by weight

Solvent: added to adjust the nonvolatile fraction to 30 weight %

“Dianal ER-55” is a non-polymerizable thermoplastic acrylic resin manufactured by Mitsubishi Rayon Co., Ltd. (weight average molecular weight: 400,000). The obtained film for hydraulic transfer had high tackiness, and when the PP film was removed, the film could not be floated on the water surface without wrinkling because of the adhesiveness of the ink surface.

### Comparative Example 5

After forming a layer of a curable resin composition (12) on a PVA film in the same manner as in the example 2, the curable resin layer of the film and the printed layer of the film P2 having a lattice pattern produced in production example 2 were positioned facing each other, and were then laminated together at 60° C., thereby forming a decorative layer on the curable resin layer.

(Curable Resin Layer Composition (12))

NK Oligo EA-1020: 65 parts by weight (solid fraction)

M-8530: 20 parts by weight (solid fraction)

Elitel UE-3380: 120 parts by weight (solid fraction)

Toluene: 135 parts by weight

Methyl ethyl ketone: 135 parts by weight

Irgacure 184: 2.5 parts by weight

“Elitel UE-3380” is a polyester resin manufactured by Unitika Ltd. (weight average molecular weight: 18,000, Tg: 60° C.).
{Polyester resin/curable resin layer}×100=75 weight %}

The PP film was removed from the obtained film for hydraulic transfer, and hydraulic transfer was attempted in the same manner as in the example 2, but the balance between the dissolution of the curable resin layer and the solubility of the decorative layer was poor, and a satisfactory transferred product could not be obtained.

### Comparative Example 6

Using the same method as the example 2, a curable resin composition (13) was applied to a PVA film of thickness 30 μm in sufficient quantity to generate a dried film thickness of 40 μm, and the curable resin layer and the printed layer of the film P2 having a lattice pattern produced in the production example 2 were positioned facing each other, and were then laminated together at 60° C., thereby forming a decorative layer on the curable resin layer.

(Curable Resin Layer Composition (13))

NK Oligo EA-1020: 80 parts by weight (solid fraction)

M-8530: 20 parts by weight (solid fraction)

UE3500: 20 parts by weight (solid fraction)

Toluene: 130 parts by weight

Methyl ethyl ketone: 120 parts by weight

Irgacure 184: 4 parts by weight

“UE3500” is a polyester resin manufactured by Unitika Ltd. (weight average molecular weight: 86,000, Tg: 35° C.).
{Polyester resin/curable resin layer}×100=20 weight %}

The PP film was removed from the obtained film for hydraulic transfer, and hydraulic transfer was attempted in the same manner as in the example 2, but because the curable resin layer dissolved too slowly, a satisfactory transferred product could not be obtained.

Table 1 shows the compositions of the curable resin layers in the examples and comparative examples, and also shows the weight ratio P of the radical polymerizable oligomer (B1) relative to the non-polymerizable thermoplastic resin (A) within the curable resin layer.

TABLE 1

| | Non-polymerizable | Radical polymerizable | |
|---|---|---|---|
| | thermoplastic resin (A) | oligomer (B1) | Weight ratio P: (B1)/(A) |
| Example 1 | Acrypet VH | B1: Unidic 17-813 | 50/50 |
| | 200,000/100° C. | 1,500/−20° C. | |
| Example 2 | Paraloid A11 | B1: Unidic 17-813 | 60/40 |
| | 125,000/100° C. | 1,500/−20° C. | |
| | Paraloid B60 | | |
| | 50,000/75° C. | | |
| Example 3 | Paraloid A11 | B1: New frontier R-2402 | 60/40 |
| | 125,000/100° C. | 1,590/−45° C. | |
| | | B2: Aronix M-305 | |
| | | 350/−49° C. | |
| Example 4 | Paraloid A11 | B1: Unidic V5500 | 70/30 |
| | 125,000/100° C. | 1,070/−4° C. | |
| Example 5 | Paraloid A11 | B1: Unidic V5500 | 30/70 |
| | 125,000/100° C. | 1,070/−4° C. | |
| | Paraloid B60 | | |
| | 50,000/75° C. | | |
| Example 6 | Byron GK 880 (polyester) | B1: NK Oligo EA-1020 | 50/50 |
| | 54,000/84° C. | 980/−7° C. | |
| | | M-8530 | |
| | | 1,200/−62° C. | |
| Example 7 | Byron GK 880 (polyester) | B1: NK Oligo EA-1020 | 50/50 |
| | 54,000/84° C. | 980/−7° C. | |
| | Byron 650 (polyester) | M-8530 | |
| | 51,000/10° C. | 1,200/−62° C. | |
| Comparative | Radical reactive acrylic resin | | |
| example 1 | 105,000/85° C. | | |
| Comparative | Beamset 700 | | |
| example 2 | 570/liquid | | |
| Comparative | Paraloid B-72 | B1: Unidic 17-813 | 20/80 |
| example 3 | 25,000 | 1,500/−20° C. | |
| Comparative | Dianal ER-55 | B1: Unidic 17-813 | 80/20 |
| example 4 | 400,000 | 1,500/−20° C. | |
| Comparative | Elitel UE-3380 | B1: NK Oligo EA-1020 | 41.5/58.5 |
| example 5 | 18,000 | 980/−7° C. | |
| | | M-8530 | |
| | | 1,200/−62° C. | |
| Comparative | UE3500 | B1: NK Oligo EA-1020 | 83/17 |
| example 6 | 86,000/35° C. | 980/−7° C. | |
| | | M-8530 | |
| | | 1,200/−62° C. | |

(Transferred Body Test Methods)

Various properties of the samples obtained in the examples were tested as follows.

(Hydraulic Transferability)

In the hydraulic transfer process in the examples and comparative examples, samples in which no surface defects were detected and the pattern was reproduced faithfully were evaluated using the symbol O, whereas those samples with obvious surface defects or a fragmented pattern were evaluated using the symbol x.

(Surface Luster Evaluation)

Surface luster was evaluated in accordance with JIS-K5400 “7.6 Specular gloss”, by measuring the specular gloss at an incident angle of 60 degrees.

(Abrasion Resistance Evaluation)

An abrasion test was conducted using traverse test equipment, wherein #000 steel wool was applied for 5 cycles (back and forth) under a load of 1 kg/9 cm², the luster was then remeasured in the same manner as in the surface luster evaluation, and the abrasion resistance was expressed in the form of a percentage indicating the level of retention of the initial luster.

(Pencil Hardness)

The pencil hardness of the coating film was measured using a “pencil scratch tester for coated film” according to JIS-K5401. The thickness of the pencil lead was 3 mm, the angle relative to the coating film was 45 degrees, the load was 1 kg, the scratch speed was 0.5 mm/minute, the scratch length was 3 mm, and the pencils used were Mitsubishi Uni pencils.

(Solvent Resistance Test)

A rubbing tester was used to rub the sample 100 times (back and forth) with absorbent cotton impregnated with MEK, using an applied weight of 1 kg, and the surface of the coating film was then examined. Samples for which there was no discoloration or change in luster were evaluated using the symbol 0, whereas samples in which discoloration and/or change was observed were evaluated using the symbol x.

TABLE 2

| | Hydraulic | Gloss | Abrasion | Pencil | Solvent |
|---|---|---|---|---|---|
| | transferability | value | resistance | hardness | resistance |
| Example 1 | ◯ | 83 | 95 | 4H | ◯ |
| Example 2 | ◯ | 90 | 85 | 2H | ◯ |
| Example 3 | ◯ | 82 | 89 | 2H | ◯ |
| Example 4 | ◯ | 84 | 88 | 3H | ◯ |
| Example 5 | ◯ | 78 | 89 | 3H | ◯ |
| Example 6 | ◯ | 100 | 88 | H | ◯ |
| Example 7 | ◯ | 100 | 80 | H | ◯ |
| Comparative | X | 55 | 70 | H | X |
| example 1 | | | | | |
| Comparative | X | 65 | 69 | H | Δ |
| example 2 | | | | | |
| Comparative | X | 62 | 50 | 3B or less | X |
| example 3 | | | | | |
| Comparative | X | 75 | 66 | B | X |
| example 4 | | | | | |
| Comparative | X | 71 | 75 | B | X |
| example 5 | | | | | |
| Comparative | X | 78 | 71 | B | ◯ |
| example 6 | | | | | |

With the examples 1 through 7 of the present invention, hydraulic transfer was performed with no deterioration in the pattern of the decorative layer, and the surface of the obtained hydraulically transferred bodies exhibited superior levels of hardness and solvent resistance.

### INDUSTRIAL APPLICABILITY

A film for hydraulic transfer of the present invention can be widely used in a variety of fields, and is of particular advantage when used with molded products that have curved surfaces and require favorable design features.

1. A film for hydraulic transfer having a supporting film comprising a water-soluble or water-swelling resin, and a transfer layer that is soluble in organic solvent provided on top of said supporting film, in which
said transfer layer comprises a curable resin layer that is curable by irradiation with an active energy beam, and a decorative layer, which contacts a transfer target body directly during hydraulic transfer and comprises an ink or a coating film, wherein
said curable resin layer is non-adhesive at room temperature, comprises:
1) a non-polymerizable thermoplastic resin (A) selected from the group consisting of acrylic resins having a weight average molecular weight within a range from 70,000 to 250,000 and polyester resins having a weight average molecular weight within a range from 30,000 to 70,000, and,
2) a radical polymerizable oligomer (B1) selected from the group consisting of epoxy acrylates, polyester acrylates, and urethane acrylates, having a weight average molecular weight within a range from 700 to 3,000 and being compatibility with said non-polymerizable thermoplastic resin (A), and
is not irradiated with an active energy beam prior to transfer of said transfer layer.

2. A film for hydraulic transfer according to claim 1, wherein a combined weight of said non-polymerizable thermoplastic resin (A) and said radical polymerizable oligomer (B1) within said curable resin layer is 60 weight % or greater.

3. A film for hydraulic transfer according to claim 1, wherein said non-polymerizable thermoplastic resin (A) is an acrylic resin and said radical polymerizable oligomer (B1) is a urethane acrylate.

4. A film for hydraulic transfer according to claim 1, wherein said non-polymerizable thermoplastic resin (A) is a polyester resin and said radical polymerizable oligomer (B1) is a polyester acrylate.

5. A film for hydraulic transfer according to claim 1, wherein said curable resin layer further comprises a polymerizable compound (B2) with a weight average molecular weight of at least 200 but less than 700.

6. A film for hydraulic transfer according to claim 1, having a release film on top of said transfer layer at an interface with said transfer layer.

7. A hydraulically transferred body with a cured resin layer, generated by using a film for hydraulic transfer according to claim 1 to hydraulically transfer said transfer layer to said transfer target body, and then curing said curable resin layer by irradiation with an active energy beam.
